(19) United States
(12) Patent Application Publication
(10) Pub. No.: US 2007/0006048 A1
(43) Pub. Date: Jan. 4, 2007

(54) Method and apparatus for predicting memory failure in a memory system

(75) Inventors: Vincent J. Zimmer, Federal Way, WA (US); Gundrala D. Goud, Olympia, WA (US); Rahul Khanna, Beaverton, OR (US); Mallik Bulusu, Olympia, WA (US); Satish K. Rai, University Place, WA (US); Michael A. Rothman, Puyallup, WA (US)

Correspondence Address: LAWRENCE CHO;C/O PORTFOLIOIP, P. O. BOX 52050, MINNEAPOLIS, MN, 55402, US

(73) Assignee: Intel Corporation

(21) Appl. No.: 11/169,408

(22) Filed: Jun. 29, 2005

(51) Int. Cl. G06F 11/00

(52) U.S. Cl. 714/42

(57) ABSTRACT

A method for managing a memory system includes comparing one or more conditions of a memory with historical memory data that predicts a future state of the memory. According to one embodiment, updating the historical memory data includes accumulating operation data on the memory during its operation, generating updated historical memory data with the operation data, and updating the historical memory data with the updated historical memory data. Other embodiments are described and claimed.

### TECHNICAL FIELD

Embodiments of the present invention pertain to managing a memory system. More specifically, embodiments of the present invention relate to a method and apparatus for predicting memory failure in a memory system using historical data.

### BACKGROUND

Memory has become more reliable due to better manufacturing processes and memory protection technologies such as error correction codes (ECC). Hot pluggable memory systems have also been made available which allow for memory to meet reliability, availability, and serviceability (RAS) goals. Hot pluggable memory systems allow memory to be added or replaced without taking a computer system off-line. This is ideal for computer systems running memory intensive and mission critical applications for databases, enterprise resource planning, customer relationship management, web serving, e-commerce, and other applications.

The use of many of today's memory system solutions are conditioned upon a failure detection of memory. Thus, because the use of some of these technologies is ex post facto of a failure, there may be occasions where data is lost during the time before memory replacement or memory migration. Failure prediction techniques have been implemented on memory systems to determine when a memory component may fail. Since memory failure often results after a number of errors occur, many of these prediction techniques involve logging various memory errors and determining when a threshold number of errors has been reached. Many of these prediction techniques are unsophisticated and have been only minimally effective in predicting the occurrence of actual memory failures.

### BRIEF DESCRIPTION OF THE DRAWINGS

The features and advantages of embodiments of the present invention are illustrated by way of example and are not intended to limit the scope of the embodiments of the present invention to the particular embodiments shown.

FIG. 1 is a block diagram of a first embodiment of a computer system in which an example embodiment of the present invention resides.

FIG. 2 is a block diagram of a second embodiment of a computer system in which an example embodiment of the present invention resides.

FIG. 3 is a block diagram of a basic input output system used by a computer system according to an example embodiment of the present invention.

FIG. 4 is a block diagram of a prediction module according to an example embodiment of the present invention.

FIG. 5 is a flow chart illustrating a method for managing a memory system according to an example embodiment of the present invention.

### DETAILED DESCRIPTION

In the following description, for purposes of explanation, specific nomenclature is set forth to provide a thorough understanding of embodiments of the present invention. However, it will be apparent to one skilled in the art that these specific details may not be required to practice the embodiments of the present invention. In other instances, well-known circuits, devices, and programs are shown in block diagram form to avoid obscuring embodiments of the present invention unnecessarily.

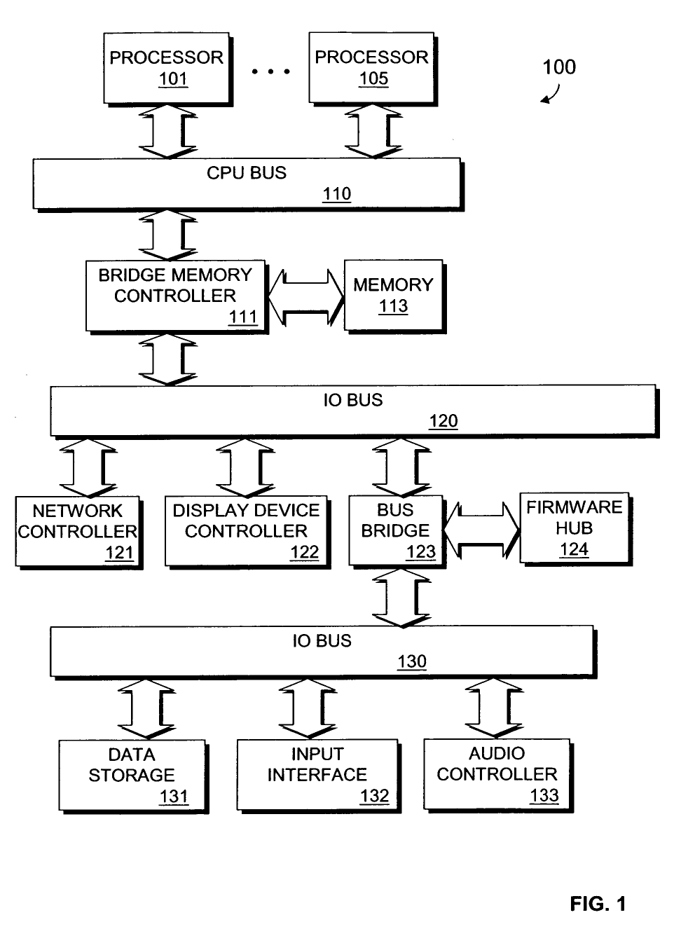

FIG. 1 is a block diagram of a first embodiment of a computer system 100 in which an example embodiment of the present invention resides. The computer system 100 includes one or more processors that process data signals. As shown, the computer system 100 includes a first processor 101 and an nth processor 105, where n may be any number. The processors 101 and 105 may be complex instruction set computer microprocessors, reduced instruction set computing microprocessors, very long instruction word microprocessors, processors implementing a combination of instruction sets, or other processor devices. The processors 101 and 105 may be multi-core processors with multiple processor cores on each chip. The processors 101 and 105 are coupled to a CPU bus 110 that transmits data signals between processors 101 and 105 and other components in the computer system 100.

The computer system 100 includes a memory 113. The memory 113 includes a main memory that may be a dynamic random access memory (DRAM) device. The memory 113 may store instructions and code represented by data signals that may be executed by the processors 101 and 105. A cache memory (processor cache) may reside inside each of the processors 101 and 105 to store data signals from memory 113. The cache may speed up memory accesses by the processors 101 and 105 by taking advantage of its locality of access. In an alternate embodiment of the computer system 100, the cache may reside external to the processors 101 and 105.

A bridge memory controller 111 is coupled to the CPU bus 110 and the memory 113. The bridge memory controller 111 directs data signals between the processors 101 and 105, the memory 113, and other components in the computer system 100 and bridges the data signals between the CPU bus 110, the memory 113, and a first input output (IO) bus 120.

The first IO bus 120 may be a single bus or a combination of multiple buses. The first IO bus 120 provides communication links between components in the computer system 100. A network controller 121 is coupled to the first IO bus 120. The network controller 121 may link the computer system 100 to a network of computers (not shown) and supports communication among the machines. A display device controller 122 is coupled to the first IO bus 120. The display device controller 122 allows coupling of a display device (not shown) to the computer system 100 and acts as an interface between the display device and the computer system 100.

A second IO bus 130 may be a single bus or a combination of multiple buses. The second IO bus 130 provides communication links between components in the computer system 100. A data storage device 131 is coupled to the second IO bus 130. The data storage device 131 may be a hard disk drive, a floppy disk drive, a CD-ROM device, a flash memory device or other mass storage device. An input interface 132 is coupled to the second IO bus 130. The input interface 132 may be, for example, a keyboard and/or mouse controller or other input interface. The input interface 132 may be a dedicated device or can reside in another device such as a bus controller or other controller. The input interface 132 allows coupling of an input device to the computer system 100 and transmits data signals from an input device to the computer system 100. An audio controller 133 is coupled to the second IO bus 130. The audio controller 133 operates to coordinate the recording and playing of sounds.

A bus bridge 123 couples the first IO bus 120 to the second IO bus 130. The bus bridge 123 operates to buffer and bridge data signals between the first IO bus 120 and the second IO bus 130. A firmware hub 124 is coupled to the bus bridge 123. The firmware hub 124 may be coupled to the bus bridge 123 via a low-pin-count (LPC) bus or other connection. According to one embodiment, the firmware hub 124 includes a non-volatile memory such as read only memory. The non-volatile memory stores instructions and code represented by data signals that may be executed by the processor 101 and/or processor 105. The computer system basic input output system (BIOS) may be stored on the non-volatile memory. Alternately, an extensible framework interface and a platform innovation framework may be used in place of the BIOS where the computer system 100 implements the Extensive Firmware Interface Specification (EFI 1.10 Specification, published 2004).

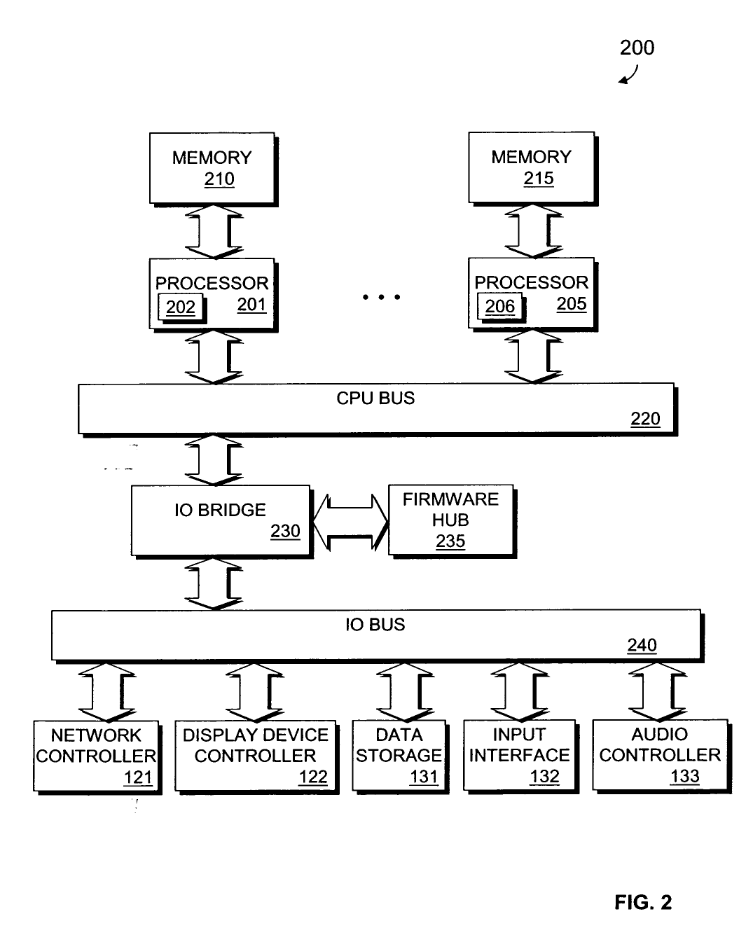

FIG. 2 illustrates a block diagram of a second embodiment of a computer system 200 in which an example embodiment of the present invention resides. The computer system 200 includes components which are similar to those described with reference to FIG. 1. The computer system 200 includes one or more processors that process data signals. As shown, the computer system 200 includes a first processor 201 and an nth processor 205, where n may be any number. The processors 201 and 205 may be complex instruction set computer microprocessors, reduced instruction set computing microprocessors, very long instruction word microprocessors, processors implementing a combination of instruction sets, or other processor devices. The processors 201 and 205 may be multi-core processors with multiple processor cores on each chip.

According to an embodiment of the computer system 200, the processors 201 and 205 each include memory controllers 202 and 206, respectively. The memory controllers 202 and 206 allow processors 201 and 205 to interface directly with and utilize memory 210 and 215 respectively. The memory 210 and 215 may each include a main memory that may be a dynamic random access memory (DRAM) device. The memory 210 and 215 may store instructions and code represented by data signals that may be executed by the processors 210 and 215.

The processors 201 and 205 are coupled to a CPU bus 220 that transmits data signals between processors 201 and 205 and other components in the computer system 200.

An IO bridge 230 is coupled to the CPU bus 220. The IO bridge 230 directs data signals between the processors 201 and 205, and other components in the computer system 200 and bridges the data signals between the CPU bus 220 and an input output bus 240. Although a single IO bus 240 is shown in FIG. 2, it should be appreciated that the IO bridge 230 may include a plurality of IO slots to allow interfacing with a plurality of IO buses.

A firmware hub 235 is coupled to the IO bridge 230. According to an embodiment of the computer system 200, the firmware hub 235 includes a non-volatile memory such as read only memory. The non-volatile memory stores instructions and code represented by data signals that may be executed by the processors 201 and/or 205. The computer system BIOS may be stored on the non-volatile memory. Alternately, an extensible framework interface and a platform innovation framework may be used in place of the BIOS where the computer system 100 implements the Extensive Firmware Interface Specification. According to an alternate embodiment of the computer system 200, the firmware hub 235 may be connected to a bridge controller connected to the IO bus 240.

The IO bus 240 may be a single bus or a combination of multiple buses. The IO bus 240 provides communication links between components in the computer system 200. The components may include a network controller 121, a display device controller 122, a data storage device 131, an input interface 132, an audio controller 133, and/or other devices.

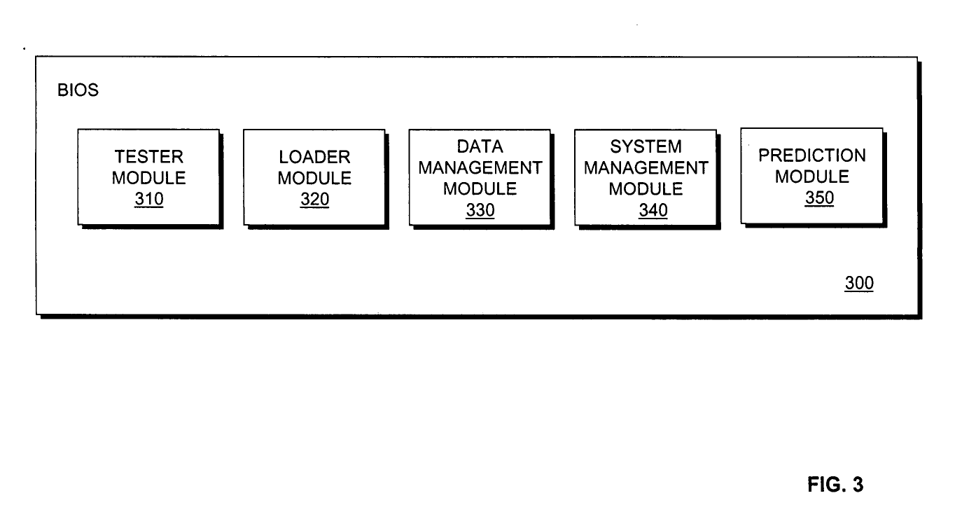

FIG. 3 is a block diagram of a BIOS 300 used by a computer system according to an example embodiment of the present invention. The BIOS 300 may be used to implement the BIOS stored in a firmware hub such as the one shown as 124 in FIG. 1 or 235 shown in FIG. 2 for example. The BIOS 300 includes programs that may be run when a computer system is booted up and programs that may be run in response to triggering events. The BIOS 300 may include a tester module 310. The tester module 310 performs a power-on self test (POST) to determine whether the components on the computer system are operational.

The BIOS 300 may include a loader module 320. The loader module 320 locates and loads programs and files to be executed by a processor on the computer system. The programs and files may include, for example, boot programs, system files (e.g. initial system file, system configuration file, etc.), and the operating system.

The BIOS 300 may include a data management module 330. The data management module 330 manages data flow between the operating system and components on the computer system. The data management module 330 may operate as an intermediary between the operating system and components on the computer system and operate to direct data to be transmitted directly between components on the computer system.

The BIOS 300 may include a system management mode module 340. According to an embodiment of the present invention, a memory controller, such as the bridge memory controller 111 (shown in FIG. 1) or memory controllers 202 and 206 (shown in FIG. 2), identifies various events and timeouts. When such an event or timeout occurs, a system management interrupt (SMI) is asserted which puts a processor into system management mode (SMM). In SMM, the system management module 340 saves the state of the processor(s) and redirects all memory cycles to a protected area of main memory reserved for SMM. The system management mode module 340 includes an SMI handler. The SMI handler determines the cause of the SMI and operates to resolve the problem. According to an embodiment of the present invention, platform management interrupts (PMI), or other types of interrupts may be asserted.

The BIOS 300 includes a prediction module 350. Upon receiving notification of a memory error, the prediction module 350 compares one or more conditions of the memory with historical memory data. The historical memory data may include information that predicts a future state of the memory. For example, the historical memory data may indicate that the future occurrence of a memory failure is likely based upon the occurrence of an error type, error location, operating temperature of the memory, or other criteria. Upon predicting a failure of the memory, the prediction module 350 generates an appropriate response to address the failure. According to an embodiment of the BIOS 300, the prediction module 350 updates the historical memory data using operation data of the memory or other memories in a memory system.

It should be appreciated that the BIOS 300 may include additional modules to perform other tasks. The tester module 310, loader module 320, data management module 330, system management module 340, and prediction module 350 may be implemented using any appropriate procedure or technique. According to an embodiment of the present invention where a computer system is compliant with the EFI Specification, the BIOS 300 and its components may be implemented using a plurality of modular interfaces based on drivers.

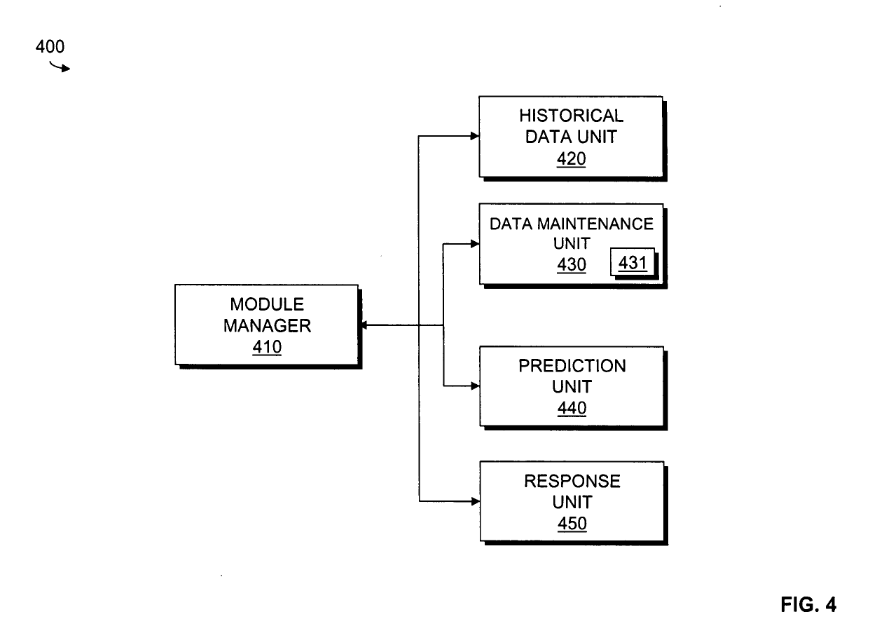

FIG. 4 is a block diagram of a prediction module 400 according to an example embodiment of the present invention. The prediction module 400 may be implemented as the prediction module 350 shown in FIG. 3. The prediction module 400 includes a module manager 410. The module manager 410 interfaces with and transmits information between other components in the prediction module 400.

The prediction module 400 includes a historical data unit 420. According to an embodiment of the prediction module 400, the historical data unit 420 includes historical memory data that predicts a future state of a memory given one or more known or previous conditions of the memory. The historical memory data may include probabilities of future states calculated using statistical analysis such as Bayes Theorem or other techniques. The historical memory data may be generated from properties of the memory identified from manufacturing data, field data, operation data of the memory itself, and/or other data. The historical data unit 420 may store actual tables of historical memory data or alternatively build out tables of historical memory data when executed.

The prediction module 400 includes a data maintenance unit 430. According to an embodiment of the prediction module 400, the data maintenance unit 430 may interface with components internal and/or external to a computer system in which the prediction module 400 resides to retrieve historical memory data to initialize and/or update the historical data unit 420. The prediction module 400 may accumulate operation data from one or more memories from a memory system. The operation data may include data related to the operation of the memory and/or memory system such as different error types that have occurred, the timing of the error occurrence, the location of the error, the temperature of the component experiencing the error, the make and model of the component, and/or other information that may prove useful in predicting future states of memories.

According to an embodiment of the prediction module 400, the data maintenance unit 430 includes an analysis unit 431. The analysis unit 431 performs statistical analysis on the operation data to generate historical memory data that may be used to predict future states of memories. The statistical analysis may include, for example, Bayesian analysis. Bayes' Theorem allows the probability of a first event to be determined based on knowing the probability of a second event. Given unconditional probabilities P(Bi) (prior probabilities), conditional probabilities P(A|Bi) (likelihoods) may be given as described with the following relationship.
P(Bi|A)=P(A|Bi)*P(Bi)/[P(A|B1)*P(B1)+. . . +P(A|Bn)*P(Bn)], where (i=1, . . . , n).
It should be appreciated that the analysis unit 431 may utilize other statistical analysis methods.

The prediction module 400 includes a prediction unit 440. The prediction unit 440 compares one or more conditions of a memory in a memory system to the historical memory data in the historical data unit 420 to predict a future state of the memory. According to an embodiment of the prediction unit 440, with every new condition that is a memory error, conditional probabilities may be re-evaluated. The conditional probabilities for a memory failure may be evaluated at test points such as when the link bit error rate (BER) reaches a threshold value and/or when single/multi-bit error occurs. The probability of a future error may be evaluated periodically on all memories or memory regions using current conditional probabilities. Advanced evaluation of a memory system by the prediction unit 440 allows prediction of memory failures and advanced migration of memories or memory regions. According to an embodiment of the present invention, bit errors on links and memory cells may be predicted using a mortality curve. Advanced evaluation of the errors using a curve-fit mechanism may be used to predict and perform the migration of a memory region.

The prediction module 400 includes a response unit 450. Upon the prediction of a memory failure, the response unit 450 operates to generate an appropriate response. The response unit 450 may initiate migration of a memory range or a memory component for memory systems that support memory migration. Alternatively, the response unit 450 may generate a notification of the memory failure and advice to service or replace a memory in response to a prediction of a memory failure.

Although the prediction module 400 has been described with reference to operating within a BIOS, it should be appreciated that the prediction module 400 may also be implemented in an application run on an out of band processor, such as a service processor. Alternatively, the prediction module 350 may be implemented in an application for an operating system or be implemented in other environments.

It should be appreciated that the module manager 410, historical data unit 420, data maintenance unit 430, analysis unit 431, prediction unit 440, and response unit 450 may be implemented using any appropriate procedure or technique.

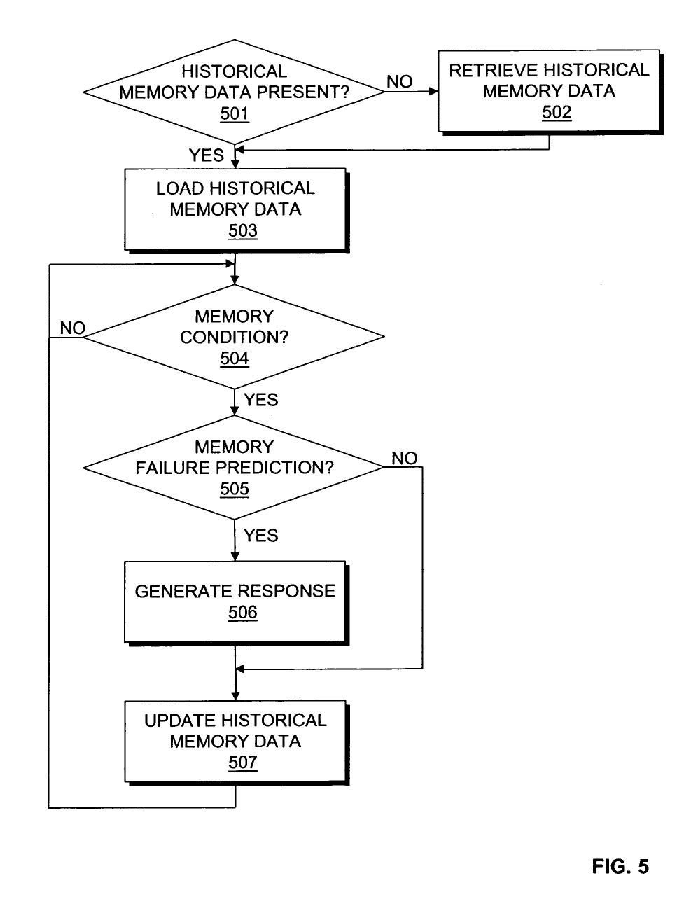

FIG. 5 is a flow chart illustrating a method for managing a memory system according to an example embodiment of the present invention. At 501, it is determined whether historical memory data is available. According to an embodiment of the present invention, a historical data unit is checked to determine whether historical memory data has been written to it. If historical memory data is not present, control proceeds to 502. If historical memory data is present, control proceeds to 503.

At 502, historical memory data is retrieved. According to an embodiment of the present invention, historical memory data may retrieved from a computer system where a memory system resides or externally.

At 503, the historical memory data is loaded. According to an embodiment of the present invention where a prediction module is implemented by a BIOS, the historical memory data may be loaded into a system management random access memory (SMRAM) that is protected from an operating system

At 504, it is determined whether a memory condition has occurred. A memory condition may be, for example, a memory error. The memory error may be one of any type of memory errors. If a memory condition has occurred, control proceeds to 505. If a memory condition has not occurred, control returns to 504.

At 505, it is determined whether a memory failure has been predicted. According to an embodiment of the present invention, the memory condition identified at 504 and/or other conditions of the memory may be analyzed with the historical memory data to predict whether a memory failure is likely. If a memory failure is predicted, control proceeds to 506. If a memory failure is not predicted, control proceeds to 507.

At 506, an appropriate response is generated. According to an embodiment of the present invention, memory migration is initiated. The memory migration may involve migrating a range of memory predicted to experience memory failure to a range of memory that is predicted to be free from failure. The memory migration may involve migrating use of a memory component predicted to fail to a spare memory component. Alternatively, for memory systems that do not support migration, the response may be the generation of a notification of predicted memory failure.

At 507, the historical memory data is updated. According to an embodiment of the present invention, the historical memory data is updated to reflect the memory condition identified at 504. It should be appreciated that the historical memory data may be updated by accumulating operation data on one or more memories in the memory system and generating updated historical memory data with the operation data. Historical memory data may be generated by performing Bayes statistical analysis or using other types of statistical analysis.

FIG. 5 is a flow chart illustrating an embodiment of the present invention. Some of the procedures illustrated in the figures may be performed sequentially, in parallel or in an order other than that which is described. It should be appreciated that not all of the procedures described are required, that additional procedures may be added, and that some of the illustrated procedures may be substituted with other procedures.

Embodiments of the present invention may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, floppy diskettes, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

In the foregoing specification, the embodiments of the present invention have been described with reference to specific exemplary embodiments thereof. It will, however, be evident that various modifications and changes may be made thereto without departing from the broader spirit and scope of the embodiments of the present invention. The specification and drawings are, accordingly, to be regarded in an illustrative rather than restrictive sense.

What is claimed is:

1. A method for managing a memory system, comprising:
comparing one or more conditions of a memory with historical memory data that predicts a future state of the memory.

2. The method of claim 1, further comprising updating the historical memory data.

3. The method of claim 2, wherein updating the historical memory data comprises:
accumulating operation data on the memory during its operation;
generating updated historical memory data with the operation data; and
updating the historical memory data with the updated historical memory data.

4. The method of claim 3, wherein generating updated historical memory data with the operation data comprises performing a Bayes statistical analysis.

5. The method of claim 2, wherein updating the historical memory data comprises retrieving updated historical memory data external from the memory system.

6. The method of claim 1, further comprising migrating the memory if the future state is memory failure.

7. The method of claim 1, further comprising generating a notification if the future state is memory failure.

8. The method of claim 1, wherein the historical memory data comprises probabilities of future states from manufacturing data.

9. The method of claim 1, wherein the historical memory data comprises probabilities of future states from field data.

10. The method of claim 1, wherein the historical memory data comprises probabilities of future states from operation data.

11. An article of manufacture comprising a machine accessible medium including sequences of instructions, the sequences of instructions including instructions which when executed cause the machine to perform:
comparing one or more conditions of a memory with historical memory data that predicts a future state of the memory.

12. The article of manufacture of claim 11, further comprising instructions which when executed cause the machine to perform updating the historical memory data.

13. The article of manufacture of claim 12, wherein updating the historical memory data comprises:
accumulating operation data on the memory during its operation;
generating updated historical memory data with the operation data; and
updating the historical memory data with the updated historical memory data.

14. The article of manufacture of claim 13, wherein generating updated historical memory data with the operation data comprises performing a Bayes statistical analysis.

15. The article of manufacture of claim 12, wherein updating the historical memory data comprises retrieving updated historical memory data external from the memory system.

16. A computer system, comprising:
a processor;
a memory; and
a prediction module to compare one or more conditions of the memory with historical memory data that predicts a future state of the memory.

17. The computer system of claim 16, wherein the prediction module further comprises a data maintenance unit to update the historical memory data with operation data from the memory.

18. The computer system of claim 16, wherein the prediction module further comprises a response unit to initiate migration of the memory in response to a memory failure prediction.

19. The computer system of claim 16, wherein the prediction module is implemented in a basic input output system and executed by the processor.

20. The computer system of claim 16, wherein the prediction module is implemented in an application and executed on an out of band processor.
